(19) United States
(12) Patent Application Publication
(10) Pub. No.: US 2016/0326461 A1
(43) Pub. Date: Nov. 10, 2016

(54) INDUSTRIAL PROCESS EQUIPMENT CLEANING OF ESTER-BASED SOILS AND MATERIALS UTILIZING ACYL TRANSFER REACTIONS

(71) Applicant: ROCHESTER MIDLAND CORPORATION, Rochester, NY (US)

(72) Inventors: Jack D. FOX, Kendall, NY (US); Nancy A. SANGER, Brockport, NY (US); Joel T. SHERTOK, Rochester, NY (US)

(21) Appl. No.: 15/110,636

(22) PCT Filed: Jan. 22, 2015
(86) PCT No.: PCT/US15/12499

§ 371 Date: Jul. 8, 2016

Related U.S. Application Data
(60) Provisional application No. 61/930,410, filed on Jan. 22, 2014.

(51) Int. Cl. C11D 3/30; C11D 11/00; C11D 3/20; C11D 1/94; C11D 3/37; C11D 3/10

(52) U.S. Cl. CPC C11D 3/30; C11D 3/3707; C11D 3/10; C11D 3/2068; C11D 1/94; C11D 11/0041

(57) ABSTRACT

A non-caustic cleaning composition and methods and uses thereof are described. The non-caustic cleaning composition can include an amine source that removes ester-based soils and materials via an acyl transfer reaction. Non-limiting examples of amines that can be used are monoethanolamine, diethanolamine, triethanolamine, triethylamine, and mixtures thereof. The composition may be an emulsion composition comprising an alkaline builder, a phase transfer catalyst, and a chelant.

### FIELD

The present disclosure relates to cleaning compositions for solid surfaces, processes of preparing the compositions, and related methods and uses.

### BACKGROUND

In food processing industries where grease, protein, starch, etc. build up into layers of varying degrees of thickness and chemical composition, periodic suspension of production runs of the process equipment to remove the build up is necessary. Various formulations and methods have been used in an attempt to resolve this problem.

Conventional formulations have included various combinations of aqueous surfactants with caustic cleaning agents, such as caustic soda (NaOH), or potash (KOH). Due to the presence of the caustic agent, the longer molecular structures of the protein, starch and grease components are cleaved into shorter-chain molecular species, which are then capable of being solubilized by water and/or surfactants and flushed away. One disadvantage to caustic cleaning agents is that they are corrosive to stainless steel at high concentrations. Additionally, caustic cleaning agents are known to decompose proteins and lipids in living tissue. This decomposition can cause a chemical burn.

Thus, there is a need for a more efficient non-caustic formulation and chemical methodology for use with various industrial cleaning operations to remove ester-based soils and materials from surfaces of equipment used in various processing industries. This and other objectives will become apparent from the following description.

### SUMMARY

In an exemplary embodiment, a cleaning composition comprises an amine source, which reacts with ester-based soils and material via an acyl transfer reaction. According to another exemplary embodiment a method of making a cleaning composition comprising an amine is provided. According to yet another embodiment a method of cleaning with a cleaning composition comprising an amine is provided.

The exemplary embodiments herein comprise a chemical methodology for cleaning one or more surfaces of processing equipment that is soiled with ester-based materials and/or byproducts, including, but not limited to, fats, oils, and greases. The materials can be soils or raw/finished process materials. On a regular basis, this equipment must be cleaned in order to maintain processing efficiency and to prevent and/or substantially inhibit the proliferation of contaminants, bacteria, viruses and other substances that can negatively affect human health and process efficiency. The improved cleaning composition and related methods include utilization of an acyl transfer reaction between amines and water-insoluble esters to produce a water-soluble or water-dispersible amide and an alcohol.

### BRIEF DESCRIPTION OF THE DRAWINGS

These and other features will now be described with reference to the drawings of certain embodiments which are intended to illustrate and not to limit the scope of the application specification and claims.

FIG. 1 shows a small fryer before CIP application.

FIG. 2 shows a small fryer after CIP application.

### DETAILED DESCRIPTION

Further aspects, features and advantages will become apparent from the detailed description which follows.

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

U.S. Pat. No. 7,507,697, which is incorporated herein by reference in its entirety, discloses a method of cleaning soiled surfaces using a cleaning formulation including an aqueous combination formed from combining a first solution comprising 0.1% by weight to approximately 50% by weight, based on the total weight of the first cleaning solution, of an alkali metal hydroxide with a second solution comprising 0.1% by weight to approximately 50% by weight, based on the total weight of the second cleaning solution, of hydrogen peroxide and a compound that generates hydrogen peroxide when dissolved in water. However, this method utilizes harmful, caustic materials.

Exemplary embodiments include a cleaning composition, a method for making the cleaning composition, and a method of using the cleaning composition.

In an exemplary embodiment, the composition is an emulsion composition comprising an alkaline builder, a phase transfer catalyst, and a chelant. In an exemplary embodiment, the emulsion composition is applied under pressure at the time of application to the surface of the food processing equipment by use of a conventional spraying device. This type of on-site cleaning operation is referred to in the industry as “environmental sanitation” or “foam cleaning” or “hard surface cleaning,” and is typically used to clean the exterior surfaces, walls and floors of food processing equipment. In another exemplary embodiment, the cleaning composition is a low-viscosity mixture that is allowed to reside in or on soiled surfaces, or is recirculated with respect to these surfaces for a pre-determined period of time. This type of cleaning operation is referred in the industry as “clean-in-place” (CIP) or “recirculation cleaning”. A preferred CIP operation applies to its use in “boil out” or “fryer boil out” cleaning operations. It can also be necessary to disassemble the surface to be cleaned in a procedure known to those in the art as cleaning out of place (COP). It is envisioned that aspects of the exemplary embodiments herein are compatible with various cleaning procedures including, for example, CIP, COP, manual cleaning, and immersion cleaning procedures.

As stated above, one exemplary embodiment involves a cleaning composition. The cleaning composition is a mildly alkaline, medium-duty, emulsion composition. The composition is a non-caustic composition. Accordingly, in exemplary embodiments it does not consist or comprise caustic soda (NaOH) or potash (KOH) or any appreciable amount thereof (i.e., less than 1%). The cleaning composition comprises an amine source as a reactive reagent. Ester-based soils and materials react with the amine source in an acyl transfer reaction such as the general reaction described below.

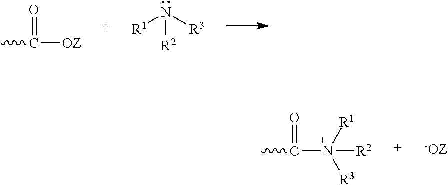

As stated above, the cleaning composition comprises an amine source, preferably, primary amines are employed. The amines, which can be derived from either a liquid or a solid, are dissolved in water to form an aqueous solution. The amine can be present in the composition from about 2% to about 50% by weight of the total weight of the composition. The preferred range is from about 5% to 30% by weight of the total weight of the composition. The most preferred range is from about 10% to about 20% by weight of the total weight of the composition. Non-limiting examples of amines that can be used are monoethanolamine, diethanolamine, triethanolamine, triethylamine, and mixtures thereof. Triethanolamine is a preferred amine due to its vapor pressure being the lowest of the ethanolamine homologous series.

In an exemplary embodiment, the cleaning composition further comprises an alkali metal salt. The alkali metal salt can be present in the composition from about 0.1% to about 10% by weight, based on the total weight of the composition. The preferred range is from about 1% to about 7% by weight, based on the total weight of the composition. The most preferred range is from about 2% to about 5% by weight, based on the total weight of the composition. Non-limiting examples of an alkali metal salts that are compatible with the cleaning composition include potassium carbonate, sodium carbonate, and mixtures thereof.

In yet another exemplary embodiment, the cleaning composition additionally comprises at least one phase coupling agent, such as a hydrotrope. An example of a suitable phase coupling agent includes, but is not limited to, diethylene glycol butyl ether (DGBE), dipropylene glycol methyl ether, tripropylene glycol methyl ether, and mixtures thereof. The phase coupling agent can be present in the cleaning composition from about 0.1% to about 15% by weight, based on the total weight of the composition. The preferred range is from about 1% to about 10% by weight, based on the total weight of the composition. The most preferred range is from about 3% to about 7%, based on the total weight of the composition.

In another embodiment, the cleaning composition further comprises at least one surfactant. Examples of suitable surfactants include, but are not limited to disodium cocoamphodiproprionate, alkyl ether hydroxypropyl sultaine, C₈E₂ linear alcohol ethoxylate, EO-PO-EO block copolymer, and mixtures thereof. The surfactant can be present in the composition from about 0.1% to about 15% by weight, based on the total weight of the first cleaning composition. A preferred range of the surfactant is from about 0.4% to about 10% by weight, based on the total weight of the composition. The most preferred range is from about 2.0% to about 7.0% by weight, based on the total weight of the composition.

In another embodiment, the cleaning composition further comprises at least one cleaning performance enhancing agent, such as an inorganic salt. Non-limiting examples of suitable cleaning performance enhancing agents include sodium metasilicate and ammonium salts, such as C₁₀-C₁₆ alkyldimethylbenzylammonium chloride, and mixtures thereof. The inorganic salt can be present from about 0.01% to about 10.0% by weight, based on the total weight of the first cleaning composition. The preferred range is from about 0.05% to about 5% by weight, based on the total weight of the composition. The most preferred range is from about 0.3% to about 2% by weight, based on the total weight of the composition.

In yet another exemplary embodiment, the cleaning composition comprises a defoamer. A non-limiting example of a suitable defoamer, includes organomodified siloxanes, such as, polydimethylsiloxane. The defoamer can be present from about 0.001% to about 1.0% by weight, based on the total weight of the cleaning composition.

A preferred range is from about 0.01% to about 0.5% by weight, based on the total weight of the composition. The most preferred range is from about 0.05% to about 0.2% by weight, based on the total weight of the composition.

In an exemplary embodiment, the cleaning composition further comprises at least one chelant and/or at least one sequestrant. Examples of a suitable chelant and/or sequestrant include, but are not limited to, sodium ethylenediaminetetraacetate (EDTA), diethylenetriamine pentaacetate (DTPA), N-(2-hydroxyethyl)ethylenediamine-N,N′,N′-triacetic acid trisodium salt (HEDTA), and mixtures thereof. The at least one chelant and/or sequestrant can be present in an amount of about 0.1% to about 10% by weight, based on the total weight of the first cleaning composition. The preferred range is from about 0.5% to about 4.0% by weight, based on the total weight of the composition. The most preferred range is from about 0.6% to about 3.0% by weight, based on the total weight of the composition.

Exemplary embodiments also include a method of making a cleaning composition and a method of using a cleaning composition. In one embodiment of the invention, the method of making a cleaning composition comprises the following steps:
a. adding an alkali metal into water and stirring the reaction mixture from about 5 minutes to about 60 minutes, preferably from about 10 minutes to about 35 minutes, and most preferably from about 10 minutes to about 15 minutes to obtain a clear aqueous solution;
b. adding at least one chelant and/or sequestrant into the aqueous solution obtained from step a and stirring the reaction mixture from about 5 minutes to about 60 minutes, preferably from about 10 minutes to about 35 minutes, and most preferably from about 10 minutes to about 15 minutes minutes to obtain a clear solution;
c. adding at least one performance enhancing agent into the solution obtained from step b and stirring the reaction mixture from about 5 minutes to about 60 minutes, preferably from about 10 minutes to about 35 minutes, and most preferably from about 10 minutes to about 15 minutes;
d. optionally, adding at least one additional chelant and/or sequestrant into the solution obtained in step c;
e. adding at least one hydrotrope into the solution obtained in step c or optional step d and stirring the reaction mixture from about 5 minutes to about 60 minutes, preferably from about 10 minutes to about 35 minutes, and most preferably from about 10 minutes to about 15 minutes, wherein stirring is performed after the addition of each hydrotrope when more than one hydrotrope is added into the reaction mixture;
f. adding an amine source into the solution obtained in step e and stirring the reaction mixture from about 5 minutes to about 60 minutes, preferably from about 10 minutes to about 35 minutes, and most preferably from about 10 minutes to about 15 minutes;
g. adding a defoamer into the solution obtained from step f and stirring the reaction mixture from about 5 minutes to about 60 minutes, preferably from about 10 minutes to about 35 minutes, and most preferably from about 10 minutes to about 15 minutes to obtain a slightly hazy aqueous emulsion;
h. adding at least one surfactant into the solution obtained in step g and stirring the reaction mixture from about 5 minutes to about 60 minutes, preferably from about 10 minutes to about 35 minutes, and most preferably from about 10 minutes to about 15 minutes, wherein stirring is performed after the addition of each surfactant when more than one surfactant is added into the reaction mixture;
i. optionally, adding additional water to dilute the solution obtained in step h; and
j. optionally, adding O₂ to the solution obtained in either step h or optional step i.

Exemplary methods can also include the steps of preparing the cleaning composition. The cleaning solution is added to a mixing tank, recirculation tank or a fixed piece of food processing equipment such as a kettle, fryer, vat or some other part of the processing equipment that is capable of holding a volume of water. In one embodiment, the equipment is filled with water prior to addition of the cleaning solution. The resulting blend is then mixed and allowed to contact the soiled surfaces by standing or by recirculation for a period of time sufficient to clean the soiled surface, followed by a water rinse.

In an exemplary embodiment, the method of preparing the cleaning composition comprises the step of diluting a stock cleaning solution. In general, the product dilution can be determined by titration with a standard such as the alkalinity kit TK-5050, which is commercially available from AquaPhoenix Scientific®. In the dilution determination, the number of drops multiplied by 0.1 is equal to the dilution percentage by volume. For example, 20 drops of the stock solution is equal to a 2% dilution (20 drops×0.1=2%).

In order to minimize safety hazards, it is advisable to initially dilute the stock solution to about 5% by volume and then optimize the dilution according to individual application needs. In one embodiment, the stock solution is diluted from about 0.5% to about 1% by volume for applications such as a beverage ready-to-drink CIP application. In another embodiment, the stock solution is diluted from about 1% to about 2% by volume for applications such as beverage concentrate CIP and bakery tank CIP applications. In yet another embodiment, the stock solution is diluted from about 5% to about 10% by volume for applications such as fryer CIP and soak/COP cleaning applications.

In another embodiment, the methods comprise the step of adding hydrogen peroxide, such as Enhance O2 at about 1% to about 2% by volume to the diluted solution. A person having ordinary skill in the art would know that Enhance O2 comprises about 28% to about 38% by volume H₂O₂ and a small amount of surfactant. This step is recommended for tougher soils. It is possible to add hydrogen peroxide prior to addition of the stock solution. In another embodiment, the methods comprise the step of adding a food-grade defoamer, for example Mid-Defoam 1111 FG or Mid-Defoam 10FG.

### EXAMPLES

Aspects of the described exemplary embodiments can be understood from the following examples, which do not limit the application's scope.

The compositions described below were prepared according to the methods and/or alternative methods described above.

Example 1:

| | Amount | | % by wt |
|---|---|---|---|
| Ethanolamine | 1.78 | lbs | 20.00 |
| Potassium carbonate | 0.445 | lbs | 5.00 |
| Tripropylene glycol methyl ether | 0.1513 | lbs | 1.70 |
| Dipropylene glycol methyl ether | 0.1513 | lbs | 1.70 |
| Diethylene glycol butyl ether | 0.3026 | lbs | 3.40 |
| Disodium cocoamphodiproprionate | 0.2136 | lbs | 2.40 |
| Alkyl ether hydroxypropylsultaine | 0.178 | lbs | 0.20 |
| C₈E₂ linear alcohol ethoxylate | 0.0801 | lbs | 0.90 |
| EOP-PO-EO block copolymer | 0.0801 | lbs | 0.90 |
| Sodium metasilicate | 0.0801 | lbs | 0.90 |
| C₁₀-C₁₆ alkyldimethylbenzylammonium | 0.02225 | lbs | 0.25 |
| chloride | | | |
| Polydimethylsiloxane | 0.0178 | lbs | 0.20 |
| Sodium ethylenediaminetetraacetate | 0.267 | lbs | 0.90 |
| Water | 0.615948 | gal. | 57.65 |

| | | | CofA¹ |
|---|---|---|---|
| Test | Method | Result | (Y/N) |
| Appearance | Visual | Slightly hazy to | Yes |
| | | clear liquid | |
| Odor | Nasal | Mild to moderate | No |
| | | detergent | |
| Specific Gravity | WI-6030 | 1.058-1.078 | Yes |
| Refractive Index | Refractometer | 1.3809-1.3859 | Yes |
| pH (2%) | WI-6012 | 11.0-11.7 | Yes |
| Alkalinity (2%)² | WI-6001 | 6.4-7.9 | No |
| | | milliequivalents³ | |

¹Certificate of Analysis
²The measurement is taken with the pH measurement sample in which
0.500N sulfuric acid is the titrant and the solution is titrated with stirring
to a pH value below 8.40. Phenolphthalien is not used as an endpoint
detection because the color change is not sharp and the pH gradually
shifts due to buffering action.
³Milliequivalents = volume titrant (mL) × normality of titrant (N, or
equivalents/Liter)

| Test | Method | Result | |
|---|---|---|---|
| % Solids | 110° C. for 2 hours¹ | 11.0%-12.2% | |
| lbs/gallon | conversion | 8.90 | lbs/gal |
| % Volatile Organic | EPA Method 24 | 26.5% | |
| Compounds (VOC) | | | |
| VOC | Conversion | 283 | g/L |
| VOC | Conversion | 2.36 | lbs/gal |

| | | |
|---|---|---|
| Flashpoint | TCC² | None to boiling |
| Shelf life | chemist | 3 years |
| Freeze/thaw | Freezer | 1 (product will freeze; |
| | | thaw, mix and use) |

¹Convection oven
²TCC—Tag closed cup, PMCC—Pensky-Marten closed cup,
COC—Cleveland open cup.

### Example 2:

| | % by wt | Purpose |
|---|---|---|
| Ethanolamine | 19.8 | Solvent |
| Potassium carbonate | 4.95 | Buffer |
| Tripropylene glycol methyl ether | 1.68 | Solvent |
| Dipropylene glycol methyl ether | 1.68 | Solvent |
| Diethylene glycol butyl ether | 3.67 | Solvent |
| Disodium cocoamphodiproprionate | 0.96 | Surfactant |
| Alkyl ether hydroxypropylsultaine | 0.84 | Surfactant |
| C₈E₂ linear alcohol ethoxylate | 0.89 | Surfactant |
| EOP-PO-EO block copolymer | 0.89 | Surfactant |
| Sodium metasilicate | 0.52* | Alkaline builder |
| C₁₀-C₁₆ alkyldimethylbenzylammonium | 0.12* | Phase Transfer |
| chloride | | Catalyst |
| Polydimethylsiloxane | 0.08* | Defoamer |
| Sodium ethylenediaminetetraacetate | 1.14* | Chelant |
| Water | 62.78 | Diluent |

### Example 3:

| | % by wt |
|---|---|
| Ethanolamine | 9.9 |
| Potassium carbonate | 2.48 |
| Tripropylene glycol methyl ether | 0.84 |
| Dipropylene glycol methyl ether | 0.84 |
| Diethylene glycol butyl ether | 1.68 |
| Disodium cocoamphodiproprionate | 0.48 |
| Alkyl ether hydroxypropylsultaine | 0.42 |
| C₈E₂ linear alcohol ethoxylate | 0.45 |
| EOP-PO-EO block copolymer | 0.45 |
| Sodium metasilicate | 0.26 |
| C₁₀-C₁₆ alkyldimethylbenzylammonium | 0.06 |
| chloride | |
| Polydimethylsiloxane | 0.05 |
| Sodium ethylenediaminetetraacetate | 0.57 |
| Water | 81.52 |

### Example 4

A kettle is rinsed and dried thoroughly then charged with 615 gallons of water. Potassium carbonate (446 lbs) is added and mixed for about 15 minutes. Then sodium metasilicate (80 lbs) is added and mixed for about 15 minutes. EDTA (268 lbs) is added and mixed to the resulting solution for about 10 minutes. Then C₁₀-C₁₆ alkyldimethylbenzylammonium chloride, 45 lbs, is added and mixed for about 10 minutes. Then DGBE (607 lbs) is added and mixed for about 10 minutes. Followed by addition of ethanolamine (1784 lbs) and the solution is mixed for about 10 minutes. Then polydimethylsiloxane (9 lbs) is added, and the solution is mixed for about 15 minutes. Followed by addition of alkyl ether hydroxypropyl sultaine (401 lbs) and the resulting solution is mixed for about 10 minutes. Then C₈E₂ linear alcohol ethoxylate (80 lbs) is added and mixed for about 10 minutes. Finally, EO-PO-EO block copolymer, 80 lbs, the resulting solution is mixed for 10 minutes, and a 8920 lbs non-caustic cleaning solution is obtained.

### Example 5

A kettle is charged with 616 gallons of water and is agitated. Then 445 lbs of potassium carbonate is added and the solution is stirred for about 10 minutes to give a clear aqueous solution. Then 80.1 lbs of sodium metasilicate is added to the aqueous solution and stirred for about 10 minutes to obtain a clear solution. Sodium ethylenediaminetetraacetate (267 lbs) is added to the reaction mixture and stirred for about 10 minutes. C₁₀-C₁₆ alkyldimethylbenzylammonium chloride (22.25 lbs) is added and the reaction mixture is agitated for about 10 minutes. Then 151.3 lbs of tripropylene glycol methyl ether is added to the solution, and the reaction mixture is agitated for 10 minutes. Followed by addition of 151.3 lbs of dipropylene glycol methyl ether, and agitation for about 10 minutes. Then 302.6 lbs of diethylene glycol butyl ether is added followed by subsequent agitation for about 10 minutes. Ethanolamine is added to the mixture and the resulting solution is stirred for about 10 minutes. The mixture is charged with 17.8 lbs of polydimethylsiloxane and stirred for about 15 minutes to give a slightly hazy solution. Then 213.6 lbs of disodium cocoamphodipropionate is added to the solution and stirred for about 10 minutes. Followed by addition of 178 lbs of alkyl ether hydroxypropylsultaine, and stirring for about 10 minutes. Then 80.1 lbs of C₈E₂ linear alcohol ethoxylate is added to the mixture and stirred for about 10 minutes. Finally, 80.1 lbs of EO-PO-EO block copolymer is added to the mixture and stirred for about 10 minutes to give 8900 lbs of a non-caustic cleaning solution.

### Example 6

To 50.03 grams of deionized water is added 19.99 grams of C₈₋₁₀E_{4.5}, the nonionic surfactant Alfonic 810-4.5, 20.02 grams of triethanolamine, and an additional 10.66 grams of deionized water. The resulting solution is a clear, transparent, homogenous solution. A 2% solution of the stock is prepared in deionized water at room temperature. The pH of the diluted solution is 10.3 and it has a conductivity of 248 μS/cm. Mechanical agitation via shaking of a 5 mL aliquot of the resulting solution produces a thick, stable foam. The solution is gradually heated with shaking to 67° C., and the foam is drastically reduced.

### Example 7

Based on the heated solution foam generation experiments and amine solvent considerations, the following test formulation was assembled. To 60.01 grams of softened water (Culligan mixed bed exchange softener system) is added 4.95 grams of potassium carbonate, 0.90 grams of sodium metasilicate pentahydrate, 0.50 grams of 50% aqueous C₁₀-C₁₆ alkyldimethylbenzylammonium chloride, 6.80 grams of diethylene glycol butyl ether, 20.00 grams of monoethanolamine, 6.80 grams of C₁₂-C₁₄ linear alcohol ethoxylate with 4.5 moles of ethoxylation, and 0.05 grams of 30% polydimethylsiloxane defoaming emulsion. This results in a clear, transparent, visually homogeneous solution.

### Example 8

A yeast tank with visible soil in layers comprising a bluish haze and protein build up is cleaned. The tank is approximately 9′×12′ with two spray balls. The spray balls are inspected for blockage prior to cleaning the tank. The soil in the tank comprises liquid yeast that has been dried on the tank surface for about 15 hours. The tank is rinsed by hand with a water hose for about 2 minutes to remove any solid chunks. The adenosine triphosphate (ATP) reading of the tank prior to CIP cleaning is 7320.

The CIP supply tank is charged with 1200 liters of water at 120° F. (48.9° C.) and 20 liters of the composition according to Example 1 to give a 1.6% by volume cleaning solution. The wash solution is heated to approximately 100° F. (37.8° C.) and has a pH of between 9 and 10. The supply pump circulates the diluted cleaning solution from the supply tank to the yeast tank via the spray balls. If necessary, the tank can be switched to manual control to extend the wash time. After 20 minutes of CIP cleaning, the supply tank is stopped and the ATP measurement of the yeast tank is 243. After 15 additional minutes of CIP cleaning, the ATP measurement of the yeast tank is 4.

The yeast tank is manually rinsed with water for about 10 minutes to allow the fog and spray to settle. Then an automatic final rinse with Trisan at 70 ppm is performed.

### Example 9

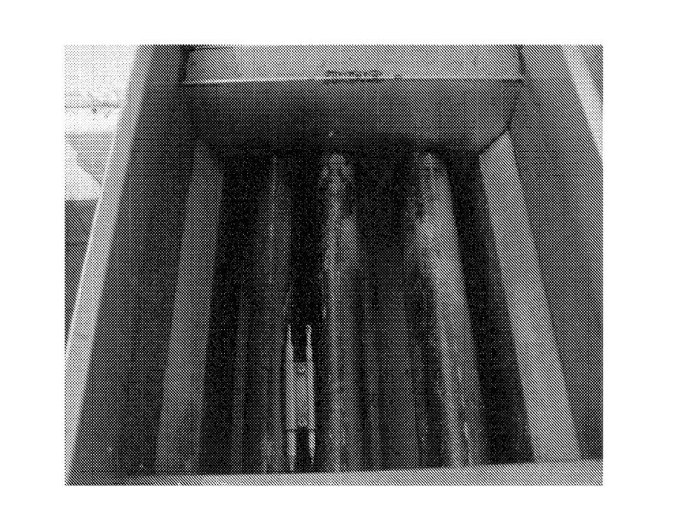

FIG. 1 shows a fryer that has been drained of oil. The fryer is then filled with hot water and the cleaning solution according to Example 1 to give a 5% by volume cleaning solution. The temperature of the diluted solution is brought to the boiling point and then the temperature is reduced. The resulting solution is allowed to soak for about 30 minutes, with occasional stirring. The upper back of the fryer is cleaned manually with the hot solution using a metal scrub pad. After about 30 minutes, the fryer is drained and inspected.

The fryer heating elements require manual cleaning for a thorough cleaning. The carbonized oil in the fryer is partially lifted away from CIP of the heating elements. The cleaning solution is reheated to boiling temperature and allowed to boil for an additional 15 minutes. Loose materials are removed with the additional cleaning at boiling temperature.

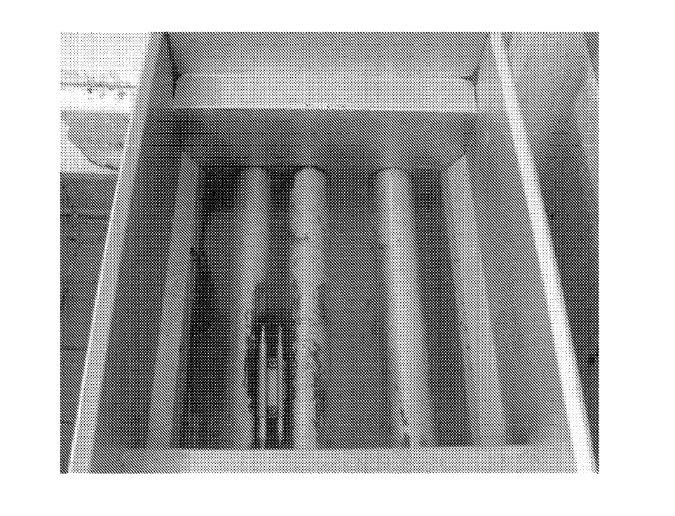

Additional rinsing and light scrubbing with dish detergent is conducted to ensure removal of all loose material. The fryer after CIP cleaning with the non-caustic cleaning solution is shown in FIG. 2.

### Example 10

A juice production assembly for concentrate juice, which comprises heavy pulp and approximately 25% to 30% sugar is cleaned with the cleaning composition. The composition of Example 1 was diluted to 0.7% by volume with water at 57° C. The assembly is equipped with a Can Line Loop 1, which pumps into Tank A. Tank A is equipped with a spray ball. Tank A pumps the solution to Tank B. Tank B is connected to Can Line Loop 2, which is a 2 inch piping to drain and is not circulated.

The CIP cleaning is performed by first rinsing water via a water hose for about 10 minutes. The 0.7% cleaning solution circulates through the assembly for about 22 minutes. This circulation is followed by a 20 minute rinse. The results are shown in Table 1 below.

TABLE 1
ATP testing before and after CIP cleaning

| | Before | After |
|---|---|---|
| Tank A | 445 | 14 |
| Tank B | 327 | 19 |
| Can Line Loop 1 | Not measured | 8 |
| Can Line Loop 2 | 2894 | 327¹ |

¹This measurement is most likely due to the poor flow of this dead end loop.

It was determined that the 0.7% cleaning composition out performed known cleaning solutions including the caustic cleaning agent HLC-3000, which comprises sodium hydroxide.

It is to be understood that the exemplary embodiments described herein are merely illustrative of the application of the principles of the claimed compositions and methods. Reference herein to details of the illustrated embodiments is not intended to limit the scope of the claims.

What is claimed is:

1. A cleaning composition comprising at least one amine, wherein the cleaning composition is non-caustic.

2. The cleaning composition according to claim 1, wherein the composition further comprises at least one alkali metal salt.

3. The cleaning composition according to claim 2, wherein the at least one alkali metal salt is selected from the group consisting of potassium carbonate, sodium carbonate, and mixtures thereof.

4. The cleaning composition according to claim 1, wherein the composition further comprises at least one phase coupling agent.

5. The cleaning composition according to claim 4, wherein the at least one phase coupling agent is selected from the group consisting of diethylene glycol butyl ether, dipropylene glycol methyl ether, tripropylene glycol methyl ether, and mixtures thereof.

6. The cleaning composition according to claim 1, wherein the composition further comprises at least one surfactant.

7. The cleaning composition according to claim 6, wherein at least one surfactant is selected from the group consisting of disodium cocoamphodiproprionate, alkyl ether hydroxypropyl sultaine, C₈E₂ linear alcohol ethoxylate, EO-PO-EO block copolymer, and mixtures thereof.

8. The cleaning composition according to claim 1, wherein the composition further comprises at least one cleaning performance enhancing agent.

9. The cleaning composition according to claim 8, wherein the at least one cleaning performance enhancing agent is selected from the group consisting of sodium metasilicate, ammonium salts, and mixtures thereof.

10. The cleaning composition according to claim 1, wherein the composition further comprises a defoamer.

11. The cleaning composition according to claim 10, wherein the defoamer is polydimethylsiloxane.

12. The cleaning composition according to claim 1, wherein the composition further comprises at least one chelant and/or at least one sequestrant.

13. The cleaning composition according to claim 12, wherein the at least one chelant and/or sequestrant is selected from the group consisting of sodium ethylenediamietetraacetate (EDTA), diethylenetriamine pentaacetate (DTPA), N-(2-hydroxyethyl)ethylenediamine-N,N′,N′-triacetic acid trisodium salt (HEDTA), and mixtures thereof.

14. The cleaning composition according to claim 1, wherein the composition further comprises:
an alkali metal salt,
at least one phase coupling agent,
at least one surfactant,
at least one performance enhancing agent,
a defoamer, and
at least one chelant and/or at least one sequestrant.

15. The cleaning composition according to claim 14, wherein the composition comprises:
2% to 50% by weight, based on the total weight of the composition, of the at least one amine;
0.1% to 10% by weight, based on the total weight of the composition, of the alkali metal salt;
0.1% to 15% by weight, based on the total weight of the composition, of the at least one phase coupling agent;
0.1% to 15% by weight, based on the total weight of the composition, of the at least one surfactant;
0.01% to 10% by weight, based on the total weight of the composition, of the at least one performance enhancing agent;
0.001% to 1% by weight, based on the total weight of the composition, of the defoamer; and
0.1% to 10% by weight, based on the total weight of the composition, of the at least one chelant and/or at least one sequestrant.

16. The cleaning composition according to claim 1, wherein the amine is selected from the group consisting of monoethanolamine, diethanolamine, triethanolamine, triethylamine, and mixtures thereof.

17. A method of making a non-caustic cleaning composition comprising the steps of:
a. adding an alkali metal into water to obtain an aqueous solution;
b. adding at least one chelant and/or sequestrant into the aqueous solution obtained in step a to obtain a solution;
c. adding at least one performance enhancing agent into the solution obtained in step b to obtain a solution;
d. optionally, adding at least one additional chelant and/or sequestrant into the solution obtained in step c to obtain a solution;
e. adding at least one hydrotrope into the solution obtained in step c or the solution obtained in optional step d to obtain a solution;
f. adding an amine source into the solution obtained from step e to obtain a solution;
g. adding a defoamer into the solution obtained in step f to obtain a solution;
h. adding at least one surfactant into the solution obtained in step g to obtain a solution;
i. optionally, adding additional water to dilute the solution obtained in step h to obtain a solution; and
j. optionally, adding O₂ to the solution obtained in step h or optional step i to obtain a non-caustic cleaning composition.

18. The method according to claim 17, wherein the non-caustic cleaning composition comprises:
2% to 50% by weight, based on the total weight of the composition, of the at least one amine;
0.1% to 10% by weight, based on the total weight of the composition, of the alkali metal salt;
0.1% to 15% by weight, based on the total weight of the composition, of the at least one phase coupling agent;
0.1% to 15% by weight, based on the total weight of the composition, of the at least one surfactant;
0.01% to 10% by weight, based on the total weight of the composition, of the at least one performance enhancing agent;
0.001% to 1% by weight, based on the total weight of the composition, of the defoamer; and
0.1% to 10% by weight, based on the total weight of the composition, of the at least one chelant and/or at least one sequestrant.

19. A method of cleaning a surface with a cleaning composition comprising the steps of:
diluting a non-caustic cleaning composition comprising an amine;
optionally, adding an enhancing agent;
optionally, adding a defoamer;
optionally, heating the diluted non-caustic cleaning composition; and
cleaning a surface with the non-caustic cleaning composition.

20. The method of cleaning with a cleaning composition according to claim 19, wherein the method is a cleaning in place (CIP) procedure.

21. The method of cleaning with a cleaning composition according to claim 20, wherein the method is a cleaning out of place (COP) procedure.
